(19) United States
(12) Patent Application Publication
(10) Pub. No.: US 2002/0091671 A1
(43) Pub. Date: Jul. 11, 2002

(54) Method and system for data retrieval in large collections of data

(76) Inventor: Andreas Prokoph, Boeblingen (DE)

Correspondence Address: SAWYER LAW GROUP LLP, P O BOX 51418, PALO ALTO, CA, 94303, US

(21) Appl. No.: 09/989,970

(22) Filed: Nov. 20, 2001

(30) Foreign Application Priority Data
Nov. 23, 2000 (DE) 00125608.0

(51) Int. Cl. G06F 7/00

(52) U.S. Cl. 707/1

(57) ABSTRACT

A method, system and computer readable medium for retrieving relevant data in large collections of documents is disclosed. The method, system and computer readable medium of the present invention includes retrieving a document to be indexed, generating a document extract from the document, wherein the document extract comprises a portion of the document, and decomposing the document extract into tokens. The tokens are then stored in a search index, wherein a search engine accesses the search index to retrieve information satifying a search query.

Through aspects of the method, system and computer readable medium of the present invention, the quality of the search result is improved because the retrieved documents are more relevant in view of the semantic concept or notion represented by the search query. Moreover the storage requirements are reduced, while expediting the processing time for conducting a search.

### CROSS-REFERENCE TO RELATED APPLICATIONS

This application claims benefit under 35 U.S.C. § 119 of EPO Application No. 00125608.0, filed Nov. 23, 2000.

1. Field of the Invention

The present invention relates to computer systems, and more specifically to retrieving data from a large collection of data.

2. Background of the Invention

Today's world is characterized by that of a “connected community;” for the business world it is called “e-business,” and for everyday people, simply “the Internet.” One of the most important and frequently utilized functions/services is search engines. These provide services aimed at finding information requested by users or applications.

Search engine providers have been pushing their search/data retrieval technology in an attempt to index the entire Internet. These approaches, however, struggle with several limitations. Due to the tremendous growth rate of the number and size of web pages, it has become very problematic for these technologies to provide the required processing power and the required storage to create and maintain the search indexes. Moreover, a typical search pattern will result in an unwieldy number of search hits, making it difficult to analyze the results. The reason for the high number of hits is that most of the retrieved documents, though containing the search pattern, will not have any semantic relationship to the intended notion behind the search pattern; that is, most of the retrieved documents are just irrelevant.

As of today, search technologies are competing to find documents relevant to the information requested by a user, thus focusing on quality rather than quantity. Conventional search engine technology is a straight forward process, involving technologies that have been well known for years. Generally, documents, e.g., web pages, are collected by a web crawler and are processed so that their contents can be stored in a fulltext index (typically an inverted index). The process is basically to build a list of keywords and their references to documents in which they were found (inversion); that is, keywords and positional information allowing the system to locate an indexed keyword or token within the processed documents. This requires splitting the document into informational units, which are composed of single words, and recording the positional information of each word (that is, the documents they appear in and their position(s) within the documents) within the index. The “keys” that are stored are the words pointing to documents together with the associated positional information (this is the inversion process). Finally, the information available in the index is exploited by later search queries to match search queries against the collection of indexed documents. The search result is a list of documents representing possible document candidates relating to the search query.

Because the result list comprises so many document candidates with little or no semantic relationship to the concept or notion of the search query, further technologies have been applied providing additional information to the user. For instance the documents on the result list can be scored in an order which represents their “relevance” to the query by taking into account the occurrences of words in the collection, and the occurrences of words in a document. These technologies are available, for example, under the terminology of “relevance ranking” and “probabilistic ranking.” Other approaches apply “popularity scores” for documents, based on how frequently they are referenced or had been visited/selected by other users. These popularity scores are then used for the ranking process of the list of result documents.

Whichever combination of the above mentioned technologies are selected, severe disadvantages adhere. The relevance of the retrieved documents is generally poor, regardless of the type of relevance measure. Therefore, users typically need to issue more than one search request to find the information they are seeking. This iterative approach slows down the search process significantly. In any case, the highly relevant documents within a search result list are embedded in an often very large number of non-relevant documents (as judged by the user in an ex-post analysis).

The above mentioned problems will increase further as the number of documents accessible via the Internet increases. The storage requirements must increase proportionally to cope with this flood of data. No only must the search engine manage huge amounts of data, it must also efficiently sift through this data and return relevant information. For example, if the user enters the query string: “problem with Epson color inkjet” into a conventional search engine, the search engine will isolate the query string into single words (optionally it could drop trivial words such as “with”) and then locate those documents where each of these occur.

Given the immense size of the Internet, e.g. Altavista can handle 200 million documents, it is obvious that each of the words will occur in a huge number of documents (>200.000). Even assuming that the common set of documents is in the range of 10,000 documents, the user cannot browse through all of these. Thus the next step is for the search engine to figure out which search hits are the most relevant. Conventional search engines determine relevance by using algorithms that take into account the information available in the search index and the search terms used. For example, the processing can comprise the following steps:

1. For each candidate document the number of occurrences of each search term is determined;

2. Given this information a rank score for each document (e.g. the normalized sum of the occurrences) is calculated;

3. Once the candidate list of documents has been completely processed, the document list is sorted by descending rank scores; and

4. The ranked list of documents is returned to the user.

Though the retrieved documents contain the words specified in the search query, a further analysis of the results leads to the following observations:

a. The words comprised by the search pattern do not occur in the requested/intended context. The retrieved documents almost never actually mention “problems with Epson printers”.

b. If the retrieved documents even relate to problems with Epson printers, these documents comprise sentences, which are variants of the following: “A problem with the Epson XYZ color printer is not known.” This search hit is actually an algorithmically determined “close” match with the query, but from a semantic point of view actually addresses a completely different context.

c. Depending on the information presented in the search query, very often the used vocabulary consists of commonly used words. The result is that in the list of the retrieved documents it is very difficult to determine the relevance of the retrieved documents. Search queries with search terms which are not very “selective” typically result in a list of retrieved documents with rank scores which are very similar, i.e., scores which do not show a strong variation (“density of rank scores”). Thus, rank scores can be an inappropriate means to distinguish between relevant and irrelevant documents.

d. Finally these problems increase at the same pace as the data volume increases.

Accordingly, what is needed is a method and system for improving the quality of a search in terms of retrieving documents which are more relevant in view of the semantic concept or notion represented by the search query. In addition, the method and system should reduce the storage requirements of conventional information structures supporting data retrieval technology. Finally, the method and system should improve processing time for processing individual data retrieval requests (search queries). The present invention addresses such a need.

### SUMMARY OF THE INVENTION

The present invention relates to a method, system and computer readable medium for retrieving relevant data in large collections of documents. The method, system and computer readable medium of the present invention include retrieving a document to be indexed, generating a document extract from the document, wherein the document extract comprises a portion of the document, and decomposing the document extract into tokens. The tokens are then stored in a search index, wherein a search engine accesses the search index to retrieve information satifying a search query.

Through aspects of the method, system and computer readable medium of the present invention, the quality of the search result is improved because the retrieved documents are more relevant in view of the semantic concept or notion represented by the search query. Moreover the storage requirements are reduced, while expediting the processing time for conducting a search.

### BRIEF DESCRIPTION OF THE DRAWINGS

FIG. 1 provides an overview of a conventional search engine.

FIG. 2 illustrates a system in block diagram form in accordance with a preferred embodiment of the present invention.

FIG. 3 is a flowchart that illustrates a process in accordance with a preferred embodiment of the present invention.

### DETAILED DESCRIPTION

The present invention relates to computer systems, and more specifically to retrieving data from a large collection of data. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

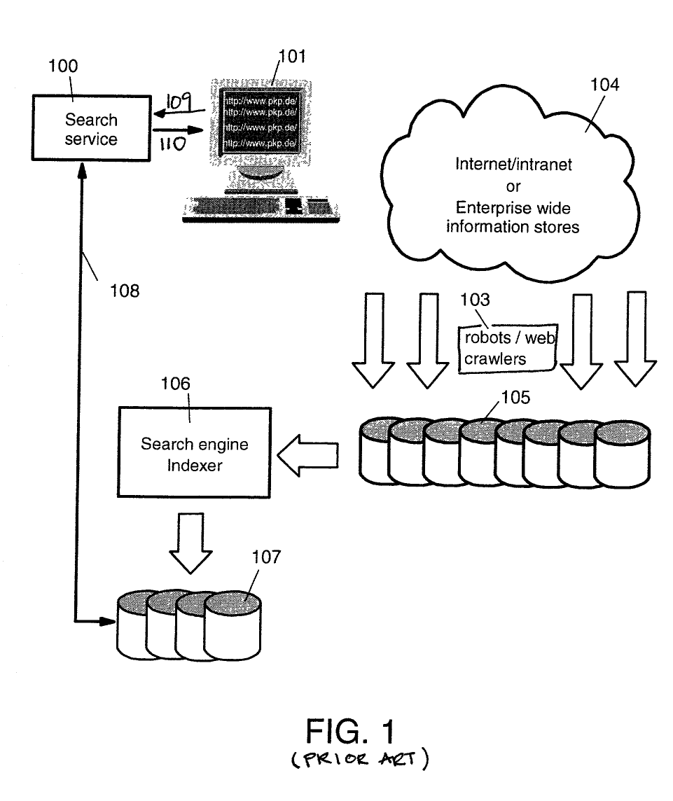

FIG. 1 provides an overview of a conventional search engine. As is shown, a search service 100 is available to a client computer system 101 (client), having a display device. The client 101 is coupled to a network 104, such as the Internet, an intranet, LAN or WAN. Web crawlers 103 retrieve documents from the network 104 and store the retrieved documents in a temporary document store 105. An indexer 106 coupled to the document store 105 parses the documents in the temporary document store 105 into individual keywords, and associates the keywords with positional information referring to their locations within the individual documents. This information is then stored in a search index 107 (an inverted index). When a search query 109 is entered into the search service 100 by the client 101, the search query 109 is used to search the index 107 only (on behalf of the large collection of documents) and a list of search hits 110 is returned to the client 101.

As stated above, the quality of the hit list 110 oftentimes is poor, i.e., the documents retrieved are not relevant, because the search index 107 it not based on semantic value of the documents.

In order to improve the quality of the hit list 110, the method and system of the present invention creates a search index that reflects the characteristic portions of a document. To that end, the method and system of the present invention utilizes an information extractor, which examines a document and generates a document extract. The document extract comprises only a portion of the document that is most characteristic for the document as a whole. Positional information related to the extract within the document is also included in the search index. As will be discussed below, data mining technology, such as the Intelligent Miner product family developed by International Business Machines Corporation of Armonk, N.Y., may be used to generate the document extract. Thus, the search index is based on the document extract, and not on the document itself.

Through aspects of the present invention, the search index is far more refined in its content because it does not contain references to inconsequential portions of a document. Moreover the size of the search index is greatly reduced because only a portion of the document is parsed. This, in turn, allows the search process to proceed more rapidly because less information is analyzed.

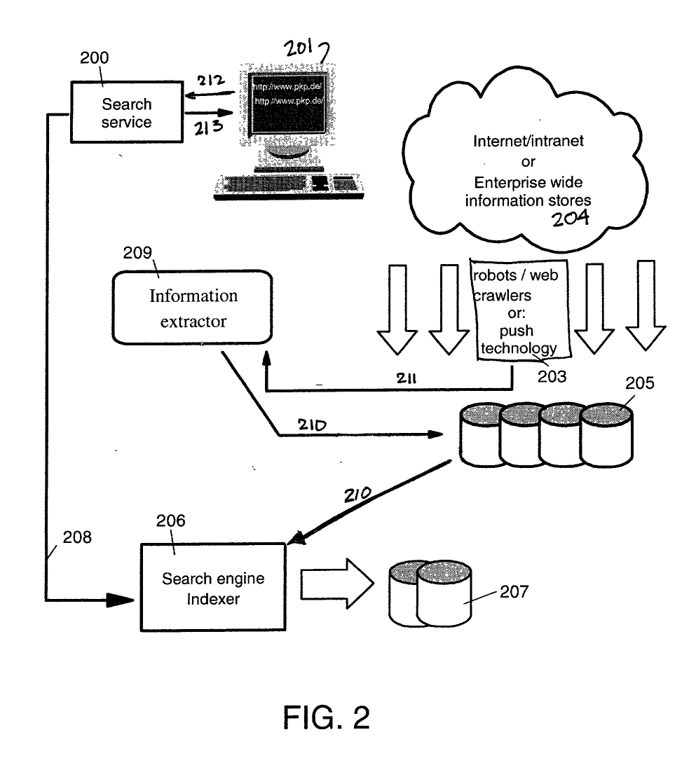

FIG. 2 illustrates a system in accordance with a preferred embodiment of the present invention. As is shown, documents from various types of document repositories in the network 204 are gathered by a web crawler 203, which employs pull or push technologies well known to those skilled in the art. An information extractor 209 (extractor) is coupled to the web crawler 203. The extractor 209 takes the retrieved document 211 and generates a new virtual document, a document extract 210, whose contents describe the information contained in the original document 211. The document extract 210 also comprises positional information referring to the contents of document extract 210 and its occurrence within the original document 211. The document extract 210 is preferably generated by data mining technology. Nevertheless, it is also possible to apply “document understanding” technology to determine the document's semantic and to generate an “abstract” of the analyzed document. The document extract 210 is intended to replace the original document 211. The extract 210 is processed further, and stored in a temporary document store 205 in place of the original document 211. The original document 211 is not required anymore and can be discarded.

As depicted in FIG. 2, the amount of storage requirements (symbolized by the number of hard disk drive icons) for the temporary document store 205 is significantly less for a the same number of documents retrieved because it stores the smaller document extract 210, and not the entire document 211. This, in turn, allows the system to store a greater number of documents before reaching capacity limits (refer to the table below).

An indexer 206 is coupled to the temporary document store 205 and decomposes the document extract 210 into a set of tokens, e.g., words, keywords, that are then stored together with their positional information in a search index 207, which forms the basis for the actual search engine. As indicated by FIG. 2, the amount of storage needed for the search index 207 is significantly reduced because it is required to store the index information of the much smaller document extract only. Finally, the search service 200 is coupled to the indexer 206, which allows the client 201 to issue search queries 212 against the search index 207. The search service 200 returns the result list 213 back to the requesting client/user 201.

The Technology Exploited by the Preferred Embodiment of the Extractor

The extractor according to the current invention analyzes a document for its informational content suppressing all those portions of a document deviating from its actual topic or theme; thus the extractor could be viewed as an instrument for the determination of a document's “relevance.” In the conventional approach, the notion of relevance of a document enters the search process at a very late stage, namely during the ranking process. Moreover the notion of relevance is determined in conjunction with a search query only. The method and system of the current invention uses a relevance approach with a scope limited to the document only. Thus, different technologies are exploited for the relevance determination. The preferred extraction process takes place before creating the information structures (e.g., the search index 207) supporting the data retrieval process.

Summarization Technology

The relevant information to be incorporated into the document extract can be determined by those sentences or parts of sentences in the document that actually contain the relevant and descriptive keywords. The area of data mining provides technologies for automatically generating from a certain document a so-called summary or abstract comprising the most relevant portion of the document. IBM's Intelligent Miner product family offers such technologies as one example. The current invention suggests to exploit this technology to generate a document extract.

A document summary, used as document extract according to the current invention, consists of a collection of sentences extracted from the document that are characteristic of the document content. A summary can be produced for any document but it works best with well-edited structured documents. Based on certain control parameters one even can specify the maximum number of sentences the summary should contain, either as an absolute number or in proportion to the length of the document. Typical summarization tools use a set of ranking strategies on word level and on sentence level to calculate the relevance of a sentence to the document. The sentences with the highest scores are extracted to form the document summary.

For example, consider the following document:

BANGALORE, India, M2 PRESSWIRE via Individual Inc.:

AT&T today launched India's first Global Network Management Centre (GNMC) to meet the networking needs of local companies and multinational corporations (MNCs) in India. AT&T will provide advanced network solutions, as well as a range of sophisticated communications services, to large Indian companies and domestic and foreign MNCs country-wide.

The GNMC will be located in Bangalore. The state-of-the-art facility is connected to AT&T's other GNMCs in China, Singapore, the United States and Europe. The facility uses the latest communications technology to manage, maintain and operate customers'networks 24-hours-a-day, 365 days-a-year. “The Bangalore GNMC shows our commitment to providing local and global customers with world-wide network management capabilities,” said Joydeep Bose, director, AT&T Managed Network Solutions, India. “This facility is a significant technological investment and is the first-ever of its kind in the country.”

The GNMC will be run by AT&T's Managed Network Solutions division, which focuses on the communications needs of MNCs world-wide. AT&T will also offer an extensive, flexible range of communications services including network analysis and design, network integration and implementation, and a complete suite of outsourced network operations management services. AT&T Managed Network Solutions will provide world-class, product-independent services for voice and data networking to help customers choose the best technology and transmission facilities the market can offer.

“More and more companies are setting up or expanding their businesses in India,” said Rakesh Bhasin, president, AT&T Managed Network Solutions, Asia/Pacific. “In order to expand efficiently, they need communications networks they can trust. AT&T can help save companies time, money and resources by offering expert advice on installing and ‘future proofing’ a network, managing it once it has been built, and making sure it provides consistent, high-quality, seamless voice and data connections.”

The above document will be summarized by the summarization technology provided by IBM's Intelligent Miner product family into:

BANGALORE, India, M2 PRESSWIRE via Individual Inc.: AT&T today launched India's first Global Network Management Centre (GNMC) to meet the networking needs of local companies and multinational corporations (MNCs) in India. The GNMC will be run by AT&T's Managed Network Solutions division, which focuses on the communications needs of MNCs world-wide.

Extraction of Tokens, Such as Characteristic Sentences, Parts of Sentences, and (Key)Words

The method and system of the current invention also exploits various other technologies from the area of data mining, alone or in combination with one another. For instance, to generate the document extract, certain words or keywords occurring within the document may be extracted based on word ranking approaches. While the complete document is analyzed, not all words in a document are scored. Typically words must fulfill one of the following criteria to be eligible for scoring:

a. The word appears in certain document structures, such as titles, headings, or captions;

b. The word occurs more often in the document than in the document collection represented by a reference vocabulary, i.e., word salience measure; or

c. The word must occur more than once in the document.

The generated score of a word consists of the salience measure if this is greater than a threshold set in the configuration file. The default salience measure can be calculated by multiplying text frequency with inverse document frequency. Moreover, further weighting factors may be introduced if a word occurs in the title, a heading, or a caption or other specific syntactical locations within a document.

In another example, to generate the document extract, certain sentences or parts of sentences occurring within the document may be extracted based on sentence ranking approaches. Sentences in a document are scored according to their relevance to the document and their position in a document. The sentence score may be defined as the sum of:

a. The scores of the individual words in the sentence multiplied by a coefficient set in the configuration file;

b. The proximity of the sentence to the beginning of its paragraph multiplied by a coefficient set in the configuration file;

c. Final sentences in long paragraphs and final paragraphs in long documents receive an extra score; and

d. The proximity of a paragraph to the beginning of the document multiplied by a coefficient set in the configuration file.

The highest ranking sentences are extracted to create the document summary. One also can specify the length of the summary to be a number of sentences or a percentage of the document's length.

Alternatively, a keyword list (e.g. domain specific words) can be used to extract those parts/words of the document that are in close proximity to each of the listed keywords, thus focusing on a subset of documents.

In another preferred embodiment, the document extract is generated by extracting features occurring within the document based on feature extraction technology. Feature extraction technology focuses on extracting the basic pieces of information in text—such as terms made up of a collection of individual words, e.g., company names or dates mentioned. Information extraction from unconstrained text is the extraction of the linguistic items that provide representative or otherwise relevant information about the document content. These features can be extracted or used to: assign documents to categories in a given scheme; group documents by subject; or focus on specific parts of information within documents. The extracted features can also serve as meta data about the analyzed documents.

The feature extraction component of IBM's Intelligent Miner® product family recognizes significant vocabulary items in text. The process is fully automatic, i.e., the vocabulary is not predefined. When analyzing single documents, the feature extractor can operate in two possible modes. In the first, it analyzes the document in isolation. In a second preferred mode, it locates vocabulary in the document that occurs in a dictionary which it has previously built from a collection of similar documents. When using a collection of documents (second mode), the feature extractor is able to aggregate the evidence from many documents to find the optimal vocabulary.

For example, it can often detect the fact that several different items are really variants of the same feature, in which case it picks one as the canonical form. In addition, it can then assign a statistical significance measure to each vocabulary item. The significance measure, called “Information Quotient” (IQ), is a number which is assigned to every vocabulary item/feature found in the collection. Thus, for example, features that occur more frequently within a single document than within the whole document collection are rated high. The calculation of IQ uses a combination of statistical measures which together measure the significance of a word, phrase or name within the documents in the collection.

Based on above mentioned technologies, the extractor 209 can determine whether there is relevant information within the document by controlling threshold values. Put another way, the quality of a document extract can be controlled by setting threshold information. The generated document extract, as a whole, can have a relevance score assigned (based on its sub-components), denoting how well the extract describes the contents of a document. In a range of 1 to 100, relevance scores above a certain threshold, e.g., 75%, indicate that the extract is a good descriptor of the overall document. This knowledge can be used to determine whether a document should be stored in the search index at all. For instance, a document identified as “John Doe's home page” is most likely of no interest to the global Internet community. So it is a candidate to drop completely.

A similar problem relates to “spaming”, which refers to introducing a huge amount of data not related to the web site at all just to increase the probability of being found by many “typical search requests”. The method and system of the present invention would automatically detect such documents as irrelevant and not consider them to be stored in the search index. Thus, the extractor 209 is able to disregard documents without any relevance, i.e., a document extract would not be generated.

Integrating the Extractor Within a Data Retrieval Architecture

With respect to incorporation of the information extractor 209 within an existing data retrieval architecture several possibilities will be suggested. It is important to note, that the incorporation of the extractor 209 within the existing system providing search capabilities, can be done with very few or no changes to the existing architecture.

According to the method and system of the present invention, the extractor 209 hooks into an existing search system at the point between the physical fetching of a document from a document repository (e.g. the Internet or a document management system like an electronic library) and the point where the token list for a document is inserted into the search index 207.

In a first embodiment, the extractor 209 can be incorporated as an extension of the process of fetching a document 203 (e.g. a web crawler (pull technology) or a push agent). It has the significant advantage of reducing the storage requirements for the temporary document store 205 as only the much smaller document extract instead of the original document has to be stored.

In a second embodiment, the extractor 209 can be incorporated as a daemon process which manipulates the documents that are temporarily stored on disk 205 before the search index is enhanced by the indexer 206. For that purpose the extractor 209 could be invoked, for instance, by file system notification services.

In a third embodiment, the extractor 209 can be incorporated as an additional document analysis process invoked as a preprocessing phase to the indexer 206, before tokenization of document(s) is performed. For this purpose the extractor 209 could be invoked by the indexer 206.

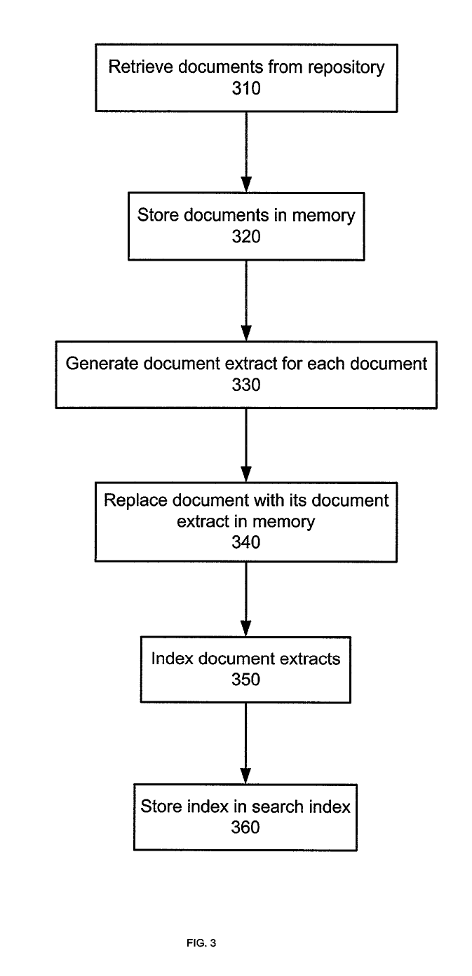

FIG. 3 is a flowchart illustrating a process according to a preferred embodiment of the present invention. The process begins in step 310, where documents are retrieved from a document repository, such as the Internet or an internal library. In one preferred embodiment, the robot to retrieve the documents is an IBM web crawler. In step 320, the documents are stored temporarily on hard disks 205. Next, the information extractor 209, implemented as a “stand-alone” application, generates a document extract, comprising for example, a three sentence summary, via step 330. The document extract can be generated using conventional information mining technology such as that provided by Intelligent Miner for Text developed by IBM. In step 340, the original document is replaced with its document extract.

The indexer 206, then picks up the document extracts and indexes them, via step 350. The index is then stored in the search index 207 for use by the search engine 200. Processing time is allocated for the execution of the extractor 209. Nevertheless, compared to the conventional approach, where the entire original document is indexed (tokenized) to enhance the search index, the benefits of utilizing the extractor 209 outweighs the costs of the extra processing overhead because indexing the document extract is far less taxing than indexing the entire document. Moreover, because the search index is concentrated and smaller and the associated document reference list is smaller, the overall search performance improves.

By utilizing the method and system of the present invention, more relevant documents can be indexed because the document extract takes up less space than the entire document. Table 1 provides a comparison between the convention system and the system according to the present invention.

TABLE 1

| Traditional | | |
|---|---|---|
| Total number of documents | 900,000,000 | documents |
| average size of a document | 5120 | bytes |
| traditional search engine | 4291.53 | GBytes data to be |
| | | processed |
| resulting index size | 1502.04 | GBytes index size |
| New | | |
| relevant documents in total (20%) | 180,000,000 | documents |
| output of the “information | 512 | bytes |
| condenser” | | |
| information condenser” enabled | 85 | GBytes data to be |
| search engine | | processed |
| resulting index size | 30 | GBytes index size |

As can be seen, extractor based search service according to the current invention requires only 30 GBytes disk space for its search index, as opposed to 1500 Gbytes for conventional search engines. Moreover, because only about 20% of the analyzed documents are relevant, the system of the present invention will generate a document extract only for approximately 20% of the documents. In a conventional system, a single high end server cannot handle this amount of data. Therefore an Internet search service today is based on a cluster of typically more than 50 of these servers. On the other hand, with an index of merely 30 GBytes it woule be possible to host such a search service on a single high-end server.

Advantages of the Invention

Besides improvements of the current invention with respect to storage requirements and processing time for individual search requests, the current invention improves the quality of the search results significantly. The relevance or precision of the returned search hits match the semantic “notion or concept” expressed by the search pattern much more accurate than traditional technology.

The advantages of current invention can be understood best by a comparison with conventional search engines returning relevant documents, relevancy displayed by rank order of the result list and optionally rank scores per document for which presumably the first document in the list is the best match for the query. Statistics taken from big search engine installations show that 40% of the “words” indexed will never be searched for; this portion comprises artificial words, explicit numeric values (not approximations like 1999, or 1.000.000) and the like. Another 40% of words in a document are “filler words” required to “ornament” the text and the overall appearance of the text not introducing further semantics into a document. The remaining 20% can be considered to be relevant to the informational content of the document. The method and system of the current invention locates specifically this 20% portion of a document and will extract this into the document extract.

The search quality according to the current invention can be measured, for instance, by the quotient between “recall” and “precision” defined as “relevance”. Recall refers to the number of documents returned for a given query. Precision refers to the number of the recalled documents which are relevant to the query (in an ex post investigation). Ideally, the quotient would be 1.0, realistically, however, an optimum is in the range of 0.3 to 0.5.

The influence of “the information condensing” according to the current invention on these factors for improving the search quality can easily be understood. The “recall” measure is decreased by dropping documents from the index completely determined as irrelevant due to lack of information overall. Thus “coincidentally” containing a certain keyword will not occur. Therefore in general the number of documents that contain a keyword are decreased by the extractor preprocessing step.

The “precision” is increased on the other hand by condensing of information for a given document by selecting the most characteristic portions of a document. Multi-word search requests will thus distinguish “good” from “lesser good” matches due to their close proximity (e.g. occurring in same sentence). The number of occurrences overall in the document will also indicate a higher relevancy. In essence, as the recall decreases and the precision increases the overall quotient will grow towards 1.0 and thus improve.

The responsiveness of the search service according to the current invention will definitely benefit from the lesser amount of information needed to be looked up in the search index, which is also a quality aspect of the search service.

Although the present invention has been described in accordance with the embodiments shown, one of ordinary skill in the art will readily recognize that there could be variations to the embodiments and those variations would be within the spirit and scope of the present invention. For instance, although the current invention has been described within the context of the search problem in the Internet, it is only representative of any search problem where a large number of documents are stored in a repository such as that commonly found in many large organizations or corporations. These repositories may easily surpass the current size of the Internet (2 to 8 Terabytes of data) in terms of the shear number of documents and the amount of occupied storage. Accordingly, many modifications may be made by one of ordinary skill in the art without departing from the spirit and scope of the appended claims.

What is claimed is:

1. A method for retrieving information using a search engine comprising the steps of:
(a) retrieving a document to be indexed;
(b) generating a document extract corresponding to the document;
(c) decomposing the document extract into a plurality of tokens; and
(d) storing the plurality of tokens in a search index, wherein the search engine accesses the search index to retrieve information in one or more document extracts satisfying a search query.

2. The method of claim 1, wherein the generating step (b) further comprises the steps of;
(b1) extracting a portion of the document that characterizes the document's subject content to form the document extract; and
(b2) recording positional information of the portion extracted within the document.

3. The method of claim 2, further comprising the step of:
(e) storing the document extract in a storage device.

4. The method of claim 3, wherein the storing step (d) further comprises:
(d1) storing the recorded positional information with the plurality of tokens.

5. The method of claim 4, wherein the extracting step (b1) further comprises the step of:
(b1i) extracting from the document a collection of sentences that are characteristic of the document's subject content to form a document summary.

6. The method of claim 4, wherein the decomposing step (c) further comprises:
(c1) selecting from the document extract one of a whole sentence, a portion of a sentence, a word, and a feature.

7. The method of claim 6, wherein the selecting step (c1) further comprises:
(c1i) selecting based on frequency of occurrence, word-salient-measure, proximity to the beginning of a paragraph, proximity the beginning of the document, and proximity to or position within a heading or a caption.

8. The method of claim 1, wherein the document is a web-page in the Internet.

9. A computer readable medium containing programming instructions for retrieving information using a search engine comprising the instructions for:
(a) retrieving a document to be indexed;
(b) generating a document extract corresponding to the document;
(c) decomposing the document extract into a plurality of tokens; and
(d) storing the plurality of tokens in a search index, wherein the search engine accesses the search index to retrieve information in one or more document extracts satisfying a search query.

10. The computer readable medium of claim 9, wherein the generating instruction (b) further comprises the instructions for:
(b1) extracting a portion of the document that characterizes the document's subject content to form the document extract; and
(b2) recording positional information of the portion extracted within the document.

11. The computer readable medium of claim 3, further comprising the instruction for:
(e) storing the document extract in a storage device.

12. The computer readable medium of claim 11, wherein the storing instruction (d) further comprises the instruction for:
(d1) storing the recorded positional information with the plurality of tokens.

13. The computer readable medium of claim 12, wherein the extracting instruction (b1) further comprises the instruction for:
(b1i) extracting from the document a collection of sentences that are characteristic of the document's subject content to form a document summary.

14. The computer readable medium of claim 12, wherein the decomposing instruction (c) further comprises the instruction for:
(c1) selecting from the document extract one of a whole sentence, a portion of a sentence, a word, and a feature.

15. The computer readable medium of claim 14, wherein the selecting instruction (c1) further comprises the instruction for:
(c1i) selecting based on frequency of occurrence, word-salient-measure, proximity to the beginning of a paragraph, proximity the beginning of the document, and proximity to and position within a heading and a caption.

16. The computer readable medium of claim 9, wherein the document is a web-page in the Internet.

17. A system for retrieving information, wherein the system includes a search engine comprising:
means for retrieving a document from a document repository;
an information extractor coupled to the means for retrieving, wherein the information extractor generates a document extract corresponding to the document;
a storage device coupled to the information extractor for storing the document extract;
a search engine indexer coupled to the storage device for decomposing the document extract into a plurality of tokens; and
a search index coupled to the search engine indexer for storing the plurality of tokens, wherein the search engine accesses the search index to retrieve information in one or more document extracts satisfying a search query.

18. The system of claim 17, wherein the information extractor extracts a portion of the document that characterizes the document's subject content to form the document extract, and records positional information of the portion extracted within the document.

19. The system of claim 18, wherein the search index stores the positional information associated with the plurality of tokens.

20. The system of claim 19, wherein a token of the plurality of tokens comprises one of a whole sentence, a portion of a sentence, a word, and a feature of the document.

21. The system of claim 20, wherein the search engine indexer selects the plurality of tokens based on frequency of occurrence, word-salient-measure, proximity to the beginning of a paragraph, proximity the beginning of the document, and proximity to and position within a heading and a caption.

22. The system of claim 17, wherein the document respository is the Internet and the document is a web-page.

23. The system of claim 22, wherein the means for retrieving the document is a web crawler.
